(19) United States
(12) Patent Application Publication
(10) Pub. No.: US 2024/0152731 A1
(43) Pub. Date: May 9, 2024

(54) HARDWARE-AWARE ZERO-COST NEURAL NETWORK ARCHITECTURE SEARCH SYSTEM AND NETWORK POTENTIAL EVALUATION METHOD THEREOF

(71) Applicant: Industrial Technology Research Institute, Hsinchu (TW)

(72) Inventors: Yao-Hua Chen, Changhua County (TW); Jiun-Kai Yang, Taichung City (TW); Chih-Tsun Huang, Hsinchu City (TW)

(73) Assignee: Industrial Technology Research Institute, Hsinchu (TW)

(21) Appl. No.: 18/349,982

(22) Filed: Jul. 11, 2023

(30) Foreign Application Priority Data
Nov. 3, 2022 (TW) 111141975

(51) Int. Cl. G06N 3/045

(52) U.S. Cl. CPC G06N 3/045

(57) ABSTRACT

A hardware-aware zero-cost neural network architecture search system is configured to perform the following. A neural network search space is divided into multiple search blocks. Each of the search blocks includes multiple candidate blocks. The candidate blocks are guided and scored through a latent pattern generator. The candidate blocks in each of the search blocks are scored through a zero-cost accuracy proxy. One of the candidate blocks included in each of the search blocks is sequentially selected as selected candidate blocks, the selected candidate blocks are combined into multiple neural networks to be evaluated, and network potential of the neural networks to be evaluated is calculated according to scores of the selected candidate blocks. One neural network to be evaluated with the highest network potential is selected to determine the corresponding selected candidate blocks.

### CROSS-REFERENCE TO RELATED APPLICATION

This application claims the priority benefit of Taiwan application serial no. 111141975, filed on Nov. 3, 2022. The entirety of the above-mentioned patent application is hereby incorporated by reference herein and made a part of this specification.

### TECHNICAL FIELD

The disclosure relates to a neural network search technology, and more particularly, to a hardware-aware zero-cost neural network architecture search system and a network potential evaluation method thereof.

### BACKGROUND

In recent years, the deep neural network has been widely used in various fields. The conventional neural network architecture design requires researchers or engineers to repeatedly design the network architecture, then actually train it on the training data set, and then test its performance on the verification data set. However, such development has poor search efficiency in the search space of the network architecture. In order to speed up the design of the high-performance network architecture, neural architecture search (NAS) came into being, making it possible to automatically and efficiently conduct neural architecture search, and it has become one of the commercial service projects of major companies in recent years, such as AutoML of Google and AutoDL of Baidu. On the other hand, in response to the actual deployment of the neural network on the hardware requirements, the neural architecture search is designed as a hardware-aware neural network architecture search according to the requirements so that the searched neural network meets the hardware requirements.

In the neural architecture search, there are also problems similar to the aforementioned manual neural network architecture design, such as the time cost of repeated training and evaluation of the neural network, GPU performance requirements, large energy consumption, etc., which have always been important issues in the neural architecture search. As the neural network becomes more and more complex in order to cope with real situations, training and verification of the neural network also requires more time, and the speed of the neural architecture search becomes the key to the time that affects the research and the deployment of the neural network in the industry. Therefore, it is extremely necessary to develop further algorithms for faster neural architecture search.

In recent years, the development of the neural architecture search still faces many difficulties. The main difficulty is that in most cases, the faster the search speed is, the less accurate the neural network will be evaluated, and it is necessary to make a trade-off between the search speed and the found network performance. Usually, if the established model is required to be a model optimized for the search space, it will take more time. Especially in recent years, the width, depth, and number of parameters of the neural network have been greatly increased to enhance the performance of the neural architecture search, and the speed of the neural architecture search is extremely important. Therefore, how to quickly and effectively search for a high-performance neural network to meet the requirements of the rapid design and deployment of the neural network in recent years is a topic that requires breakthroughs.

### SUMMARY

The disclosure provides a hardware-aware zero-cost neural network architecture search system, including memory and a processor. The memory is configured to store neural networks. The processor is coupled to the memory to divide a neural network search space into multiple search blocks, in which each of the search blocks includes multiple candidate blocks; guide and score the candidate blocks through a latent pattern generator; score the candidate blocks in each of the search blocks through a zero-cost accuracy proxy; sequentially select candidate blocks from the candidate blocks of each of the search blocks, combine the selected candidate blocks into multiple neural networks to be evaluated, and calculate network potential of the neural networks to be evaluated according to scores of the selected candidate blocks; and select one neural network to be evaluated with the highest network potential from the neural networks to be evaluated to determine the selected candidate blocks corresponding to the neural network to be evaluated with the highest network potential.

The disclosure provides a network potential evaluation method of a hardware-aware zero-cost neural network architecture search system, including the following. A neural network search space is divided into multiple search blocks. Each of the search blocks includes multiple candidate blocks. The candidate blocks are guided and scored through a latent pattern generator. The candidate blocks are scored through a zero-cost accuracy proxy. Selected candidate blocks are sequentially selected from the candidate blocks of each of the search blocks, the selected candidate blocks are combined into multiple neural networks to be evaluated, and network potential of the neural networks to be evaluated is calculated according to scores of the selected candidate blocks. One neural network to be evaluated with the highest network potential is selected from the neural networks to be evaluated to determine the selected candidate blocks corresponding to the neural network to be evaluated with the highest network potential.

Based on the above, the hardware-aware zero-cost neural network architecture search system and the network potential evaluation method thereof in the disclosure is a combination of two neural architecture search (NAS) technologies, such as the blockwise NAS and zero-cost NAS, that have great speed advantages in current academic publications, significantly improving the search efficiency of the state-of-the-art (SOTA) neural architecture search (NAS) in recent years. Faced with different depths of the blocks in the neural network, techniques such as normalization and ranking are used to address the issue that the zero-cost NAS evaluation technology is generally inaccurate, to optimize the search efficiency of the search space, and to improve the ranking capability to evaluate the accuracy of the neural network.

### BRIEF DESCRIPTION OF THE DRAWINGS

FIG. 1 is an architecture diagram of a hardware-aware zero-cost neural network architecture search system according to an embodiment of the disclosure.

FIG. 2 is a block diagram of a hardware-aware zero-cost neural network architecture search system according to an embodiment of the disclosure.

FIG. 3 is a block diagram of guiding and scoring a candidate block through a pre-trained teacher neural network model in a hardware-aware zero-cost neural network architecture search system according to an embodiment of the disclosure.

FIG. 4 is a block diagram of guiding and scoring a candidate block through a Gaussian normal distributed random model in a hardware-aware zero-cost neural network architecture search system according to an embodiment of the disclosure.

FIG. 5 is a flowchart of a network potential evaluation method of a hardware-aware zero-cost neural network architecture search system according to an embodiment of the disclosure.

### DETAILED DESCRIPTION OF DISCLOSED EMBODIMENTS

Some embodiments of the disclosure accompanied with the drawings will now be described in detail. For the reference numerals recited in the description below, the same reference numerals shown in different drawings will be regarded as the same or similar elements. These embodiments are only a part of the disclosure and do not disclose all the possible implementations of the disclosure.

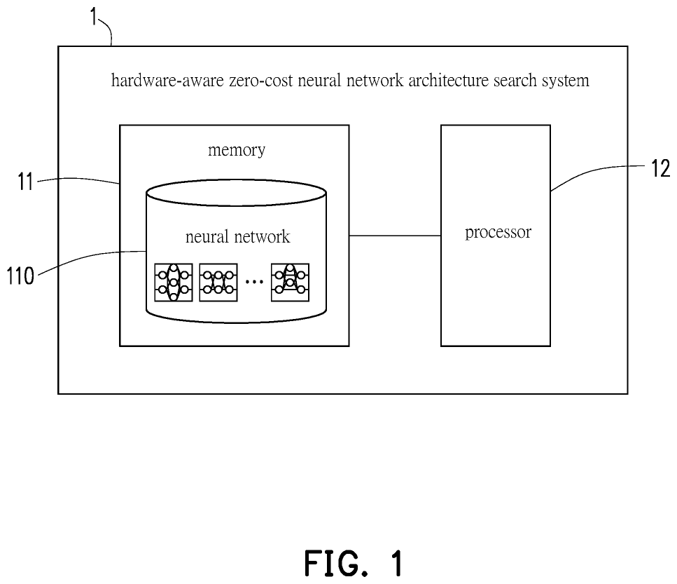

FIG. 1 is an architecture diagram of a hardware-aware zero-cost neural network architecture search system 1 according to an embodiment of the disclosure. Referring to FIG. 1, the hardware-aware zero-cost neural network architecture search system 1 includes a memory 11 and a processor 12. The memory 11 is configured to store neural networks 110, and the processor 12 is coupled to the memory 11.

Practically speaking, the hardware-aware zero-cost neural network architecture search system 1 may be implemented by computer devices, such as desktop computers, notebook computers, tablet computers, workstations, etc., with computing functions, display functions, and networking functions, and the disclosure is not limited thereto. The memory 11 is, for example, a static random-access memory (SRAM), a dynamic random-access memory (DRAM), or other memories. The processor 12 may be a central processing unit (CPU), a microprocessor, or an embedded controller, and the disclosure is not limited thereto.

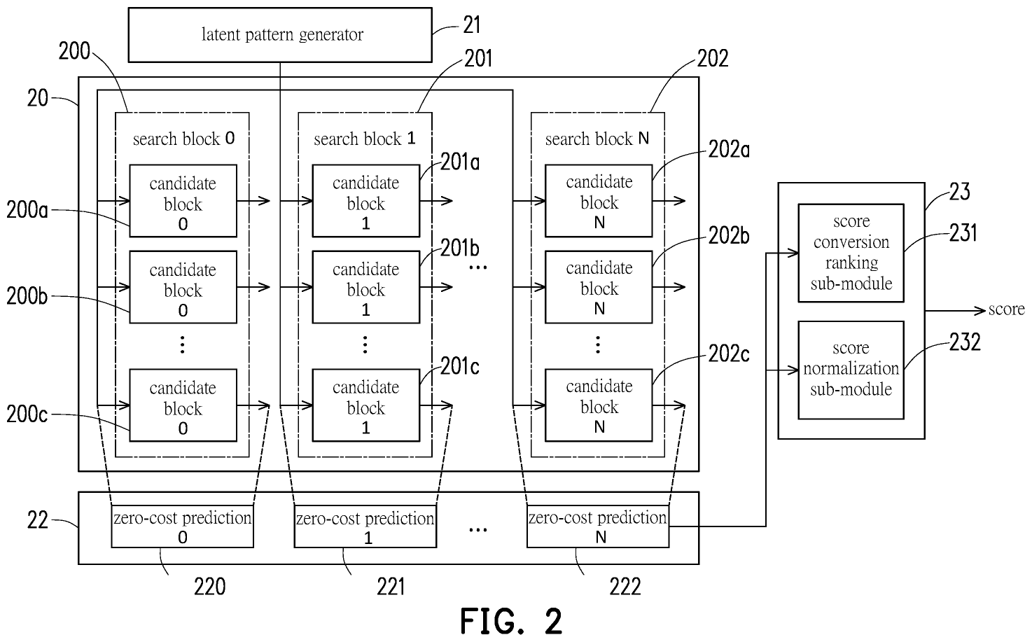

FIG. 2 is a block diagram of a hardware-aware zero-cost neural network architecture search system according to an embodiment of the disclosure. Referring to FIGS. 1 and 2, the processor 12 divides a search space 20 of the neural network 110 into multiple search blocks in units of blocks, such as a search block 0 200, a search block 1 201, . . . , a search block N 202 as shown in FIG. 2. There are N+1 search blocks in total, where N is a positive integer greater than 0.

Each of the search blocks in the search space 20 includes multiple candidate blocks. As shown in FIG. 2, the search block 0 200 has multiple candidate blocks 0 (200a to 200c). The search block 1 201 has multiple candidate blocks 1 (201a to 201c). By analogy, the search block N 202 has multiple candidate blocks N (202a to 202c).

The candidate blocks in each of the search blocks are required to have data input, and then the processor 12 may give a score to the candidate block through a candidate block computation. Therefore, the processor 12 guides and scores the candidate blocks in each of the search blocks through a latent pattern generator 21. As shown in FIG. 2, the processor 12 sequentially guides and scores the candidate blocks 0 (200a to 200c) in the search block 0 200, the candidate blocks 1 (201a to 201c) in the search block 1 201, . . . , the candidate blocks N (202a to 202c) in the search block N 202 respectively through the latent pattern generator 21.

After the processor 12 guides and scores the candidate block 0 200a to the candidate block 0 200c in the search block 0 200 through the latent pattern generator 21, the processor 12 scores the candidate blocks in each of the search block 0 200 to the search block N 202 through a zero-cost accuracy proxy 22, and records a score of each of the candidate blocks 0 in the search block 0 200 in the memory 11.

For example, assuming that the search block 0 200 includes the candidate block 0 200a, the candidate block 0 200b, and the candidate block 0 200c, the processor 12 scores the candidate block 0 200a, the candidate block 0 200b, and the candidate block 0 200c in search block 0 200 through a zero-cost prediction 0 220 of the zero-cost accuracy proxy 22. The candidate block 0 200a has a score of 7. The candidate block 1 200b has a score of 3. The candidate block 1 200c has a score of 4. The processor 12 records the scores of the candidate block 0 200a, the candidate block 0 200b, and the candidate block 0 200c in search block 0 200 in the memory 11.

Similarly, the processor 12 scores the candidate block 1 201a to the candidate block 1 201c in the search block 1 201 through a zero-cost prediction 1 221 of the zero-cost accuracy proxy 22 and records scores of the candidate block 1 201a to the candidate block 1 201c in the search block 1 201. The processor 12 scores the candidate block N 202a to the candidate block N 202c in the search block N 202 through a zero-cost prediction N 222 of the zero-cost accuracy proxy 22 and records scores of the candidate block N 202a to the candidate block N 202c in the search block N 202 in the memory 11.

After the processor 12 scores the candidate blocks in each of the search 0 200 to the search block N 202 through the zero-cost accuracy proxy 22 and records the scores of the candidate blocks in each of the search block 0 200 to the search block N 202, the processor 12 sequentially selects one of the candidate blocks from each of the search block 0 200 to the search block N 202 as selected candidate blocks and combines the selected candidate blocks into multiple neural networks to be evaluated.

For example, first, the processor 12 selects the candidate block 0 200a from the search block 0 200, selects the candidate block 1 201a from the search block 1 201, . . . , selects the candidate block N 202a from the search block N 202, which is referred to as a first selection. Therefore, the candidate block 0 200a, the candidate block 1 201a, . . . , and the candidate block N 202a are the selected candidate blocks selected by processor 12 for the first time. Then, the processor 12 combines the selected candidate blocks of the candidate block 0 200a, the candidate block 1 201a, . . . , the candidate block N 202a into a first neural network to be evaluated. Afterwards, the processor 12 again selects the candidate block 0 200b from the search block 0 200, selects the candidate block 1 201a from the search block 1 201, . . . , and selects the candidate block N 202a from the search block N 202, which is referred to as a second selection. Therefore, the candidate block 0 200b, the candidate block 1 201a, . . . , and the candidate block N 202a are the selected candidate blocks selected by processor 12 for the second time. Then, the processor 12 combines the selected candidate blocks of the candidate block 0 200a, the candidate block 1 201a, . . . , the candidate block N 202a into a second neural network to be evaluated. By analogy, the processor 12 selects the candidate blocks from the search blocks for M times to form M neural networks to be evaluated, where M is related to the number of search blocks and the number of candidate blocks in each of the search blocks.

After the M neural networks to be evaluated are combined by the processor 12, the processor 12 calculates network potential of each of the neural networks to be evaluated according to the scores of the selected candidate blocks in each of the neural networks to be evaluated. Afterwards, processor 12 selects one neural network to be evaluated with the highest network potential from the M neural networks to be evaluated so as to determine the selected candidate block corresponding to the neural network to be evaluated with the highest network potential. The neural network formed by the selected candidate blocks is a neural network architecture with the highest network potential and the highest expected accuracy.

For example, assuming that the neural network to be evaluated corresponding to the highest network potential is formed by the selected candidate block 0 200b, the selected candidate block 1 201a, . . . , the selected candidate block N 202c, the processor 12 may determine that the neural network formed by the candidate block 0 200b, the candidate block 1 201a, . . . , and the candidate block N 202c is the neural network architecture with the highest network potential and the highest expected accuracy.

In an embodiment, the processor 12 may further modify the score distribution of the candidate blocks in each of the search block 0 200 to the search block N 202 through a distribution tuner 23. The distribution tuner 23 includes a score conversion ranking sub-module 231 and a score normalization sub-module 232.

After the processor 12 scores the candidate blocks in each of the search block 0 200 to the search block N 202 through the zero-cost accuracy proxy 22, the processor 12 converts the scores of the candidate blocks in each of the search blocks into candidate block rankings through the score conversion ranking sub-module 231 of the distribution tuner 23 and modifies the score distribution of the candidate blocks according to the candidate block rankings.

Taking the search block 0 200 as an example, assuming that the search block 0 200 includes the candidate block 0 200a, the candidate block 0 200b, and the candidate block 0 200c, the candidate block 0 200a has the score of 7, the candidate block 1 200b has the score of 3, and the candidate block 1 200c has the score of 4. The processor 12 converts the scores of the candidate block 0 200a to the candidate block 0 200c into candidate block rankings of the search block 0 200 through the score conversion ranking sub-module 231 of the distribution tuner 23. That is, the candidate block 0 200a is ranked first, the candidate block 1 200c is ranked second, and the candidate block 1 200b is ranked third.

Then, the processor 12 sequentially selects one candidate block from each of the search block 0 200 to the search block N 202 as the selected candidate blocks, combines the selected candidate blocks into the neural networks to be evaluated, and selects the candidate blocks from the search blocks for multiple times to be combined into the neural networks to be evaluated.

After the neural networks to be evaluated are combined by the processor 12, the processor 12 calculates the network potential of each of the neural networks to be evaluated according to the rankings of the selected candidate blocks in each of the neural networks to be evaluated. Afterwards, the processor 12 selects one neural network to be evaluated with the highest network potential from the neural networks to be evaluated so as to determine the selected candidate block corresponding to the neural network to be evaluated with the highest network potential. The neural network formed by the selected candidate blocks is the neural network architecture with the highest network potential and the highest expected accuracy.

In another embodiment, after the processor 12 scores the candidate blocks in each of the search block 0 200 to the search block N 202 through the zero-cost accuracy proxy 22, the processor 12 normalizes the scores of the candidate blocks in each of the search blocks through the score normalization sub-module 232 of the distribution tuner 23. Then, the processor 12 modifies the score distribution of the candidate blocks according to the normalized scores of the candidate blocks in each of the search block 0 200 to the search block N 202.

Then, the processor 12 sequentially selects one candidate block from each of the search block 0 200 to the search block N 202 as the selected candidate blocks, combines the selected candidate blocks into the neural networks to be evaluated, and selects the candidate blocks from the search blocks for multiple times to be combined into the neural networks to be evaluated.

After the neural networks to be evaluated are combined by the processor 12, the processor 12 calculates the network potential of each of the neural networks to be evaluated according to the normalized scores of the selected candidate blocks in each of the neural networks to be evaluated. Afterwards, the processor 12 selects one neural network to be evaluated with the highest network potential from the neural networks to be evaluated so as to determine the selected candidate block corresponding to the neural network to be evaluated with the highest network potential.

In still another embodiment, after the processor 12 scores the candidate blocks in each of the search block 0 200 to the search block N 202 through the zero-cost accuracy proxy 22, the processor 12 converts the scores of the candidate blocks in each of the search blocks into the candidate block rankings through the score conversion ranking sub-module 231 of the distribution tuner 23, then normalizes the candidate block rankings in each of the search block 0 200 to the search block N 202 through the score normalization sub-module 232 of the distribution tuner 23, and modifies the score distribution of the candidate blocks according to the normalized scores of the candidate block rankings in each of the search block 0 200 to the search block N 202.

Then, the processor 12 sequentially selects one candidate block from each of the search block 0 200 to the search block N 202 as the selected candidate blocks, combines the selected candidate blocks into the neural networks to be evaluated, and selects the candidate blocks from the search blocks for multiple times to be combined into the neural networks to be evaluated.

After the neural networks to be evaluated are combined by the processor 12, the processor 12 calculates the network potential of each of the neural networks to be evaluated according to the normalized scores of the selected candidate blocks in each of the neural networks to be evaluated. Afterwards, the processor 12 selects one neural network to be evaluated with the highest network potential from the neural networks to be evaluated so as to determine the selected candidate block corresponding to the neural network to be evaluated with the highest network potential. The neural network formed by the selected candidate blocks is the neural network architecture with the highest network potential and the highest expected accuracy.

In an embodiment, the latent pattern generator 21 includes a pre-trained teacher neural network model and a Gaussian normal distributed random model, and the processor 12 guides and scores the candidate blocks in each of the search block 0 200 to the search block N 202 through the pre-trained teacher neural network model or the Gaussian normal distributed random model. It is particularly noted that the processor 12 does not guide and score the candidate blocks in each of the search block 0 200 to the search block N 202 through the pre-trained teacher neural network model and the Gaussian normal distributed random model at the same time. Hereinafter, the part where the processor 12 guides and scores the candidate blocks through the pre-trained teacher neural network model and the Gaussian normal distributed random model will be further described.

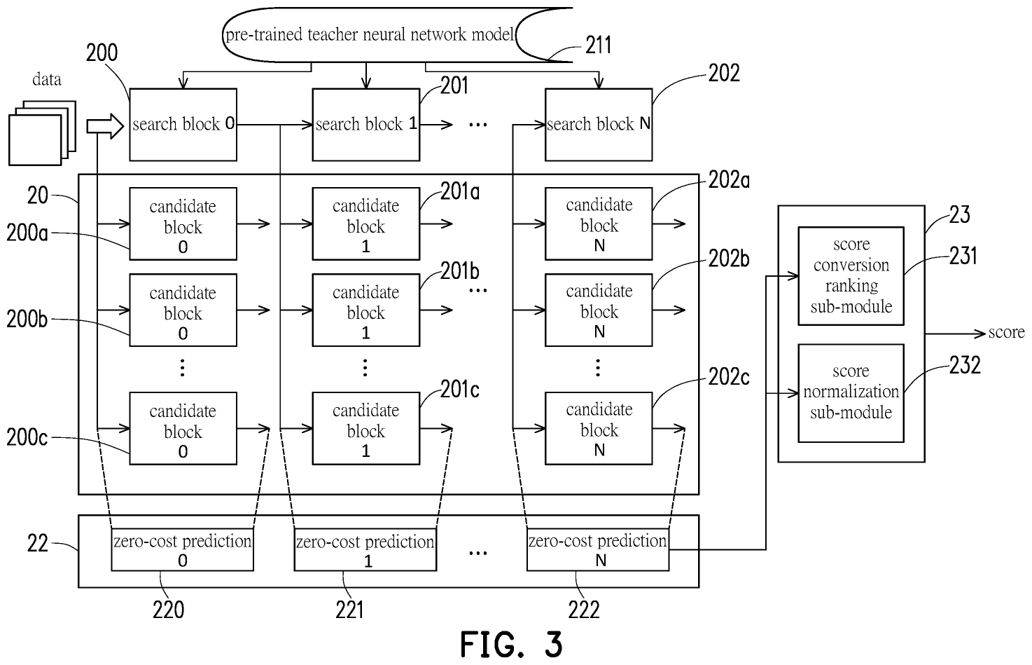

FIG. 3 is a block diagram of guiding and scoring a candidate block through a pre-trained teacher neural network model 211 in a hardware-aware zero-cost neural network architecture search system according to an embodiment of the disclosure. Referring to FIGS. 1 and 3, The pre-trained teacher neural network model 211 in the disclosure is a pre-trained neural network training model. The processor 12 divides a search space of the pre-trained teacher neural network model 211 into multiple search blocks in units of blocks, such as the search block 0 200, the search block 1 201, . . . , the search block N 202, as shown in FIG. 3. There are N+1 search blocks in total, where N is a positive integer greater than 0.

Each of the search block 0 200, the search block 1 201, . . . , the search block N 202 in the search space 20 includes the candidate blocks. As shown in FIG. 3, the search block 0 200 has the candidate blocks 0 (200a to 200c). The search block 1 201 has the candidate blocks 1 (201a to 201c). By analogy, the search block N 202 has the candidate blocks N (202a to 202c).

After the data is input into the hardware-aware zero-cost neural network architecture search system 1, the computation is performed sequentially through the search block 0 200, the search block 1 201, . . . , the search block N 202 in the search space of the pre-trained teacher neural network model 211, and at the same time, the processor 12 also guides and score the candidate blocks in each of the search blocks through the pre-trained teacher neural network model 211. As shown in FIG. 3, the processor 12 sequentially guides and scores the candidate blocks 0 (200a to 200c) in the search block 0 200, the candidate blocks 1 (201a to 201c) in the search block 1, . . . , the candidate blocks N (202a to 202c) in the search block N 202 respectively through the pre-trained teacher neural network model 211.

Then, the processor 12 scores the candidate blocks in each of the search block 0 200 to the search block N 202 through the zero-cost accuracy proxy 22. Details in this regard have been described in the previous relevant paragraphs, and thus the same details will not be repeated in the following. After the processor 12 scores the candidate blocks in each of the search block 0 200 to the search block N 202 through the zero-cost accuracy proxy 22, the processor 21 records the scores of the candidate blocks in each of the search blocks in the memory 11.

Taking the search block 0 200 as an example, the search block 0 200 is one of the search blocks in the pre-trained teacher neural network model 211 that has been pre-trained. Therefore, taking the search block 0 200 as a reference, and the processor 12 sequentially scores the candidate block 0 200a to the candidate block 0 200c corresponding to the search block 0 200 through the zero-cost prediction 0 220 of the zero-cost accuracy proxy 22, and records the scores of the candidate block 0 200a to the candidate block 0 200c included in the search block 0 200 in the memory 11.

After the processor 12 records the scores of the candidate blocks in each of the search block 0 200 to the search block N 202, the processor 12 sequentially selects one candidate block from each of the search block 0 200 to the search block N 202 as the selected candidate blocks and selects the candidate blocks from the search blocks for multiple times to be combined into the neural networks to be evaluated.

After the neural networks to be evaluated are combined by the processor 12, the processor 12 calculates the network potential of each of the neural networks to be evaluated according to the scores of the selected candidate blocks in each of the neural networks to be evaluated. Afterwards, the processor 12 selects one neural network to be evaluated with the highest network potential from the neural networks to be evaluated so as to determine the selected candidate block corresponding to the neural network to be evaluated with the highest network potential. The neural network formed by the selected candidate blocks is the neural network architecture with the highest network potential and the highest expected accuracy.

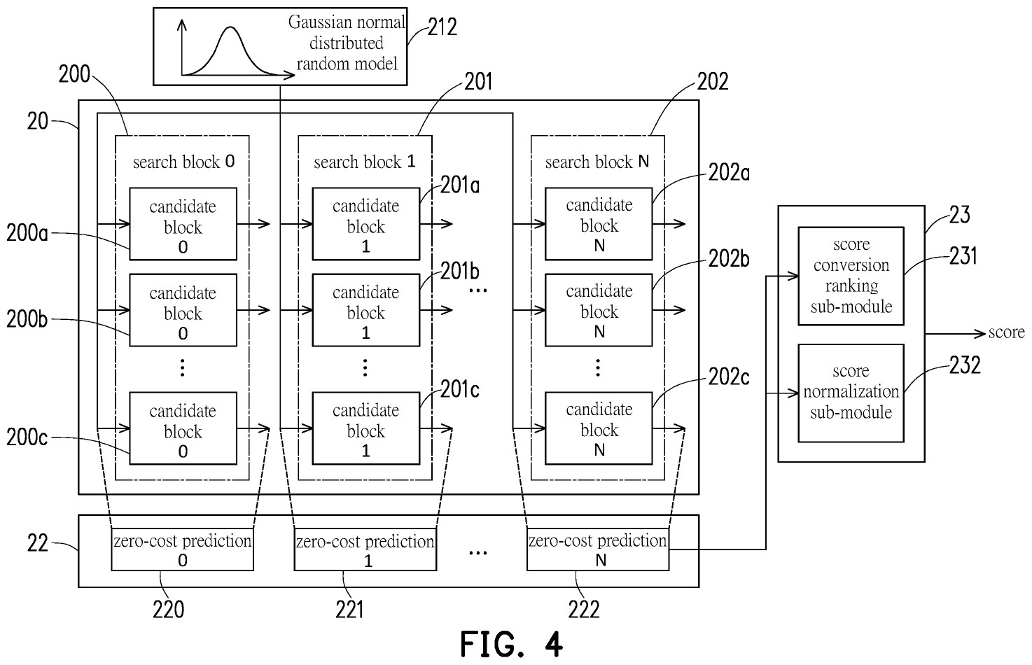

FIG. 4 is a block diagram of guiding and scoring a candidate block through a Gaussian normal distributed random model 212 in a hardware-aware zero-cost neural network architecture search system according to an embodiment of the disclosure. Referring to FIGS. 1 and 4, the Gaussian normal distributed random model 212 in the disclosure generates random noise to provide input to the search space 20 of the neural network 110.

The processor 12 guides and scores the candidate blocks in each of the search blocks through the Gaussian normal distributed random model 212. As shown in FIG. 4, the processor 12 sequentially guides and scores the candidate blocks 0 (200a to 200c) in the block 0 200, the candidate blocks 1 (201a to 201c) in the block 1 201, . . . , the candidate blocks N (202a to 202c) in the block N 202 respectively through the Gaussian normal distributed random model 212. The processor 12 sequentially scores the candidate blocks corresponding to the search block 0 200 to the search block N 202 through the zero-cost prediction 0 220 to the zero-cost prediction N 222 of the zero-cost accuracy proxy 22. The processor 12 records the scores of the candidate blocks in each of the search block 0 200 to the search block N 202.

After the processor 12 records the scores of the candidate blocks in each of the search block 0 200 to the search block N 202, the processor 12 sequentially selects one candidate block from each of the search block 0 200 to the search block N 202 as the selected candidate blocks and selects the candidate blocks from the search blocks for multiple times to be combined into the neural networks to be evaluated.

After the neural networks to be evaluated are combined by the processor 12, the processor 12 calculates the network potential of each of the neural networks to be evaluated according to the scores of the selected candidate blocks in each of the neural networks to be evaluated. Afterwards, the processor 12 selects one neural network to be evaluated with the highest network potential from the neural networks to be evaluated so as to determine the selected candidate block corresponding to the neural network to be evaluated with the highest network potential. The neural network formed by the selected candidate blocks is the neural network architecture with the highest network potential and the highest expected accuracy.

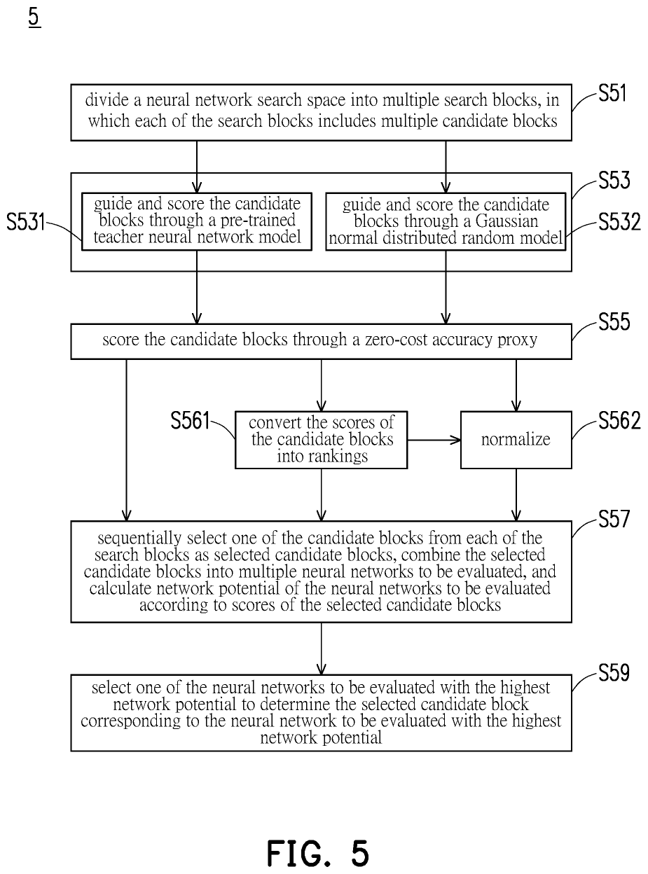

FIG. 5 is a flowchart of a network potential evaluation method 5 of a hardware-aware zero-cost neural network architecture search system according to an embodiment of the disclosure. Referring to FIG. 5, the network potential evaluation method 5 of the hardware-aware zero-cost neural network architecture search system includes step S51, step S53, step S55, step S57, and step S59.

In step S51, a neural network search space is divided into multiple search blocks. Each of the search blocks includes multiple candidate blocks. In step S53, the candidate blocks are guided and scored through a latent pattern generator.

In an embodiment, the latent pattern generator includes a pre-trained teacher neural network model and a Gaussian normal distributed random model, and the candidate blocks in each of the search blocks are guided and scored through the pre-trained teacher neural network model or the Gaussian normal distributed random model. If the latent pattern generator in the network potential evaluation method of the hardware-aware zero-cost neural network architecture search system adopts the pre-trained teacher neural network model, after step S51 is completed, step S531 in step S53 is continued. That is, the candidate blocks in each of the search blocks are guided and scored through the pre-trained teacher neural network model. If the latent pattern generator in the network potential evaluation method of the hardware-aware zero-cost neural network architecture search system adopts the Gaussian normal distributed random model, after step S51 is completed, step S532 in step S53 is continued. That is, the candidate blocks in each of the search blocks are guided and scored through the Gaussian normal distributed random model. In particular, step S531 and step S532 are not performed at the same time.

Regardless of whether the latent pattern generator in the network potential evaluation method of the hardware-aware zero-cost neural network architecture search system adopts the pre-trained teacher neural network model (step S531) or the Gaussian normal distributed random model (step S532), next, in step S55, the candidate blocks in each of the search blocks are scored through a zero-cost accuracy proxy. In step S57, one of the candidate blocks is sequentially selected from each of the search blocks as the selected candidate blocks. The selected candidate blocks are combined into multiple neural networks to be evaluated, and network potential of the neural networks to be evaluated is calculated according to scores of the selected candidate blocks. In step S59, one neural network to be evaluated with the highest network potential is selected from the neural networks to be evaluated to determine the selected candidate block corresponding to the neural network to be evaluated with the highest network potential. The neural network formed by the selected candidate blocks is the neural network architecture with the highest network potential and the highest expected accuracy.

In an embodiment, in the network potential evaluation method of the hardware-aware zero-cost neural network architecture search system, after the candidate blocks are scored through the zero-cost accuracy proxy in step S55, step S57 may be directly performed. After step S55 is performed, score distribution of the candidate blocks may be further modified first, including a method of converting the scores into rankings as in step S561 and a method of normalizing the scores as in step S562. In particular, in the network potential evaluation method of the hardware-aware zero-cost neural network architecture search system in the disclosure, after step S55 is performed, one of step S561 and step S562 may be performed separately, and then step S57 may be performed, or after step S55 is performed, step S561 is performed first, then step S562 is performed, and finally step S57 is performed.

Based on the above, the hardware-aware zero-cost neural network architecture search system and the network potential evaluation method of the hardware-aware zero-cost neural network architecture search system in the disclosure may accelerate the search speed of the neural network architecture and improve the accuracy of the neural architecture search. A search space of Blockwise NAS is used to search the search space of the full proxy, achieving the advantages of exponential space simplification. In recent years, the zero-cost Zero-cost NAS has led the academia to think about whether it is possible to complete the neural network search in a completely untrained situation. In the hardware-aware zero-cost neural network architecture search system and the network potential evaluation method of the hardware-aware zero-cost neural network architecture search system in the disclosure, space proxy and training proxy technologies are combined to achieve high-speed neural network architecture search results. In addition, the zero-cost evaluation technology is also applied to the perspective of blockwise, replacing the performance evaluation perspective of the complete network in the past, and through techniques such as normalization and ranking, the correlation between the zero-cost score and the accuracy after training may be further improved, so that the high-performance neural network may be correctly searched even without training. The combination of blockwise and zero-cost may achieve fast and accurate neural network architecture search results, and the technology proposed in the disclosure may effectively search for the high-performance neural network quickly and accurately under the trend of increasingly large neural network architecture nowadays. In addition, the technology proposed in the disclosure may also be applied to multi-exit neural network architecture search, which is suitable for the quality of service (QoS) scenario required between the cloud and users, presenting an advantageous multi-type architecture search capability.

What is claimed is:

1. A hardware-aware zero-cost neural network architecture search system, comprising:
a memory configured to store a neural network; and
a processor coupled to the memory to perform the following:
dividing a search space of the neural network into a plurality of search blocks, wherein each of the search blocks comprises a plurality of candidate blocks;
guiding and scoring the candidate blocks through a latent pattern generator;
scoring the candidate blocks in each of the search blocks through a zero-cost accuracy proxy;
sequentially selecting one of the candidate blocks from each of the search blocks as selected candidate blocks, combining the selected candidate blocks into a plurality of neural networks to be evaluated, and calculating network potential of the neural networks to be evaluated according to scores of the selected candidate blocks; and
selecting one neural network to be evaluated with the highest network potential from the neural networks to be evaluated to determine the selected candidate blocks corresponding to the neural network to be evaluated with the highest network potential.

2. The hardware-aware zero-cost neural network architecture search system according to claim 1, wherein the latent pattern generator comprises a pre-trained teacher neural network model and a Gaussian normal distributed random model, and the processor is further configured to guide and score the candidate blocks through the pre-trained teacher neural network model or the Gaussian normal distributed random model.

3. The hardware-aware zero-cost neural network architecture search system according to claim 2, wherein the processor guides and scores the candidate blocks through the pre-trained teacher neural network model or the Gaussian normal distributed random model.

4. The hardware-aware zero-cost neural network architecture search system according to claim 1, wherein the processor is further configured to modify score distribution of the candidate blocks through a distribution tuner.

5. The hardware-aware zero-cost neural network architecture search system according to claim 4, wherein the distribution tuner comprises a score conversion ranking sub-module and a score normalization sub-module.

6. The hardware-aware zero-cost neural network architecture search system according to claim 5, wherein when the processor scores the candidate blocks in each of the search blocks through the zero-cost accuracy proxy, the processor converts scores of the candidate blocks in each of the search blocks into candidate block rankings corresponding to each of the search blocks through the score conversion ranking sub-module and modifies the score distribution of the candidate blocks according to the candidate block rankings.

7. The hardware-aware zero-cost neural network architecture search system according to claim 5, wherein when the processor scores the candidate blocks in each of the search blocks through the zero-cost accuracy proxy, the processor normalizes scores of the candidate blocks in each of the search blocks through the score normalization sub-module and modifies the score distribution of the candidate blocks according to the normalized scores of the candidate blocks in each of the search blocks.

8. The hardware-aware zero-cost neural network architecture search system according to claim 5, wherein when the processor scores the candidate blocks in each of the search blocks through the zero-cost accuracy proxy, the processor converts scores of the candidate blocks in each of the search blocks into candidate block rankings corresponding to each of the search blocks through the score conversion ranking sub-module, then normalizes the candidate block rankings in each of the search blocks through the score normalization sub-module, and modifies the score distribution of the candidate blocks according to the normalized scores of the candidate blocks rankings in each of the search blocks.

9. A network potential evaluation method of a hardware-aware zero-cost neural network architecture search system, comprising:
dividing a neural network search space into a plurality of search blocks, wherein each of the search blocks comprises a plurality of candidate blocks;
guiding and scoring the candidate blocks through a latent pattern generator;
scoring the candidate blocks through a zero-cost accuracy proxy;
sequentially selecting selected candidate blocks from the candidate blocks of each of the search blocks, combining the selected candidate blocks into a plurality of neural networks to be evaluated, and calculating network potential of the neural networks to be evaluated according to scores of the selected candidate blocks; and
selecting one neural network to be evaluated with the highest network potential from the neural networks to be evaluated to determine the selected candidate blocks corresponding to the neural network to be evaluated with the highest network potential.

10. The network potential evaluation method of the hardware-aware zero-cost neural network architecture search system according to claim 9, wherein the latent pattern generator comprises a pre-trained teacher neural network model and a Gaussian normal distributed random model, and a method of calculating accuracy further comprises:
guiding and scoring the candidate blocks through the pre-trained teacher neural network model or the Gaussian normal distributed random model.

11. The network potential evaluation method of the hardware-aware zero-cost neural network architecture search system according to claim 10, further comprising:
guiding and scoring the candidate blocks through the pre-trained teacher neural network model or the Gaussian normal distributed random model.

12. The network potential evaluation method of the hardware-aware zero-cost neural network architecture search system according to claim 9, further comprising:
modifying score distribution of the candidate blocks through a distribution tuner.

13. The network potential evaluation method of the hardware-aware zero-cost neural network architecture search system according to claim 12, wherein the distribution tuner comprises a score conversion ranking sub-module and a score normalization sub-module.

14. The network potential evaluation method of the hardware-aware zero-cost neural network architecture search system according to claim 13, wherein when the candidate blocks in each of the search blocks are scored through the zero-cost accuracy proxy, scores of the candidate blocks in each of the search blocks are converted into candidate block rankings corresponding to each of the search blocks through the score conversion ranking sub-module, and the score distribution of the candidate blocks is modified according to the candidate block rankings.

15. The network potential evaluation method of the hardware-aware zero-cost neural network architecture search system according to claim 13, wherein when the candidate blocks in each of the search blocks are scored through the zero-cost accuracy proxy, scores of the candidate blocks in each of the search blocks are normalized through the score normalization sub-module, and the score distribution of the candidate blocks is modified according to the normalized scores of the candidate blocks in each of the search blocks.

16. The network potential evaluation method of the hardware-aware zero-cost neural network architecture search system according to claim 13, wherein when the candidate blocks in each of the search blocks are scored through the zero-cost accuracy proxy, scores of the candidate blocks in each of the search blocks are converted into candidate block rankings corresponding to each of the search blocks through the score conversion ranking sub-module, then the candidate block rankings in each of the search blocks are normalized through the score normalization sub-module, and the score distribution of the candidate blocks is modified according to the normalized scores of the candidate blocks rankings in each of the search blocks.
